(19) United States
(12) Patent Application Publication
(10) Pub. No.: US 2007/0230565 A1
(43) Pub. Date: Oct. 4, 2007

(54) Method and Apparatus for Video Encoding Optimization

(76) Inventors: Alexandros Michael Tourapis, Santa Clara, CA (US); Jill MacDonald Boyce, Manalapan, NJ (US); Peng Yin, West Windsor, NJ (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/597,934

(22) PCT Filed: Jun. 6, 2005
(86) PCT No.: PCT/US05/19772

§ 371 Date: Nov. 28, 2006

Related U.S. Application Data
(60) Provisional application No. 60/581,280, filed on Jun. 18, 2004.

(51) Int. Cl. H04N 7/26

(52) U.S. Cl. 375/240.01

(57) ABSTRACT

There is provided an encoder and a corresponding method for encoding video signal data corresponding to a plurality of pictures. The encoder includes an overlapping window analysis unit for performing a video analysis of the video signal data using a plurality of overlapping analysis windows with respect to at least some of the plurality of pictures corresponding to the video signal data, and for adapting encoding parameters for the video signal data based on a result of the video analysis.

### CROSS-REFERENCE TO RELATED APPLICATIONS

This application claims the benefit of U.S. Provisional Application Ser. No. 60/581,280, filed 18 Jun. 2004, which is incorporated by reference herein in its entirety.

### FIELD OF THE INVENTION

The present invention generally relates to video encoders and decoders and, more particularly, to a method and apparatus for video encoding optimization.

### BACKGROUND OF THE INVENTION

Multi-pass video encoding methods have been used in many video coding architectures such as MPEG-2 and JVT/H.264/MPEG AVC in order to achieve better coding efficiency. The idea behind these methods is to try and encode the entire sequence using several iterations, while performing an analysis and collecting statistics that could be used in future iterations in an attempt to improve encoding performance.

Two pass encoding schemes have already been used in several encoding systems, including the MICROSOFT® WINDOWS MEDIA® and REALVIDEO® encoders. According to such encoding schemes, the encoder first performs an initial encoding pass over the entire sequence using some initial predefined settings, and collects statistics with regards to the encoding efficiency of each picture within the sequence. After this process is completed, the entire sequence is reprocessed and coded one more time, while at the same time taking into account the previously generated statistics. This can considerably improve encoding efficiency, and even allow us to satisfy certain predefined encoding restrictions or requirements, such as for example satisfying a given bitrate constraint for the encoded stream. This is because the encoder is now more aware of the characteristics of the entire video sequence or picture, and thus can more appropriately select the parameters, such as quantizers, deadzoning, and so forth, that will be used for encoding. Some statistics that can be collected during this first encoding pass and can be used for this purpose are the bits per picture, the spatial activity (i.e., the average normalized macroblock variance and mean), temporal activity (i.e., the motion vectors/motion vector variance), distortion (e.g., Mean Square Error (MSE)), and so forth. Although encoding performance can be considerably improved using these methods, these also tend to be of very high complexity, can only be used offline (encode the entire sequence first and then perform a second pass), are not suitable for real-time encoders, and do not always consider all possible statistics that could be inferred from the first encoding step.

### SUMMARY OF THE INVENTION

These and other drawbacks and disadvantages of the prior art are addressed by the present invention, which is directed to a method and apparatus for video encoding optimization.

According to an aspect of the present invention, there is provided an encoder for encoding video signal data corresponding to a plurality of pictures. The encoder includes an overlapping window analysis unit for performing a video analysis of the video signal data using a plurality of overlapping analysis windows with respect to at least some of the plurality of pictures corresponding to the video signal data, and for adapting encoding parameters for the video signal data based on a result of the video analysis.

According to another aspect of the present invention, there is provided a method for encoding video signal data corresponding to a plurality of pictures. The method includes the steps of performing a video analysis of the video signal data using a plurality of overlapping analysis windows with respect to at least some of the plurality of pictures corresponding to the video signal data, and adapting encoding parameters for the video signal data based on a result of the video analysis.

These and other aspects, features and advantages of the present invention will become apparent from the following detailed description of exemplary embodiments, which is to be read in connection with the accompanying drawings.

### BRIEF DESCRIPTION OF THE DRAWINGS

The present invention may be better understood in accordance with the following exemplary figures, in which:

FIG. 1 shows a block diagram for an exemplary window based two-pass encoding architecture in accordance with the principles of the present invention;

FIG. 2 shows a plot for an impact of deadzoning during transformation and quantization in accordance with the principles of the present invention;

FIG. 3 shows a block diagram for an encoder in accordance with the principles of the present invention; and

FIG. 4 shows a flow diagram for an exemplary encoding process in accordance with the principles of the present invention.

### DETAILED DESCRIPTION OF PREFERRED EMBODIMENTS

The present invention is directed to a method and apparatus for video encoding optimization. Advantageously, the present invention allows a video encoder to compress video sequences at considerably improved subjective and objective quality given a specific bitrate. This is achieved through a non-causal processing of the video sequence, by performing a simple analysis of the current picture compared to N subsequent pictures that have yet to be coded. The results of the analysis can then be utilized by the encoder to make better decisions about the encoding parameters (including, but not limited to, picture/slice types, quantizers, thresholding parameters, Lagrangian λ, and so forth) that are to be used for the encoding of the current picture. Unlike several prior art systems that perform dual or multi-pass encoding of the entire sequence to achieve better encoding performance, the present invention is relatively simple and, thus, has a relatively small impact on complexity. The principles of the present invention may also be used in conjunction with other multi-pass encoding strategies to achieve even higher efficiency. In similar fashion, a causal system (using the M previously coded pictures) can also be created

In accordance with the principles of the present invention, only a subset overlapping picture window of the entire sequence is first analyzed. Based upon the generated statistics, the encoding parameters for each picture are appropriately adjusted. These encoding parameters may include, but are not limited to, picture/slice type decision (I, P, B), frame/field decision, B picture distance, picture or MB Quantization values (QP), coefficient thresholding, lagrangian parameters, chroma offsetting, weighted prediction, reference picture selection, multiple block size decision, entropy parameter initialization, intra mode decision, deblocking filter parameters, and so forth. Analysis methods that may require different complexity costs could be used for performing the picture/macroblock analysis, including full first pass encoding, a simple first pass motion estimation with spatial analysis, or even simple temporal and spatial analysis metrics including, but not limited to, variance, image difference, and so forth. Furthermore, the overlapping picture window (and the overlap pictures) could be as large or as small (as many or as few) as necessary, thus providing different delay/performance tradeoffs.

The present description illustrates the principles of the present invention. It will thus be appreciated that those skilled in the art will be able to devise various arrangements that, although not explicitly described or shown herein, embody the principles of the invention and are included within its spirit and scope.

All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means that can provide those functionalities as equivalent to those shown herein.

In accordance with the principles of the present invention, a new multi-pass encoding architecture is disclosed which, unlike previous methods that consider either the entire video sequence or independent windows during each pass, performs each pass on overlapping windows which allows previously determined characteristics to be reused between adjacent windows. This architecture can still achieve the benefits of multi-pass encoding, such as significantly enhanced video quality, albeit at a lower cost/complexity and with smaller memory requirements/low latency since the optimal encoding can be achieved using far fewer steps. This feature is especially important in real time encoding applications, considering that due to similarities between adjacent windows, it is possible for the encoder to decide the best parameters even during the first pass, thus requiring no further iterations for the final encoding.

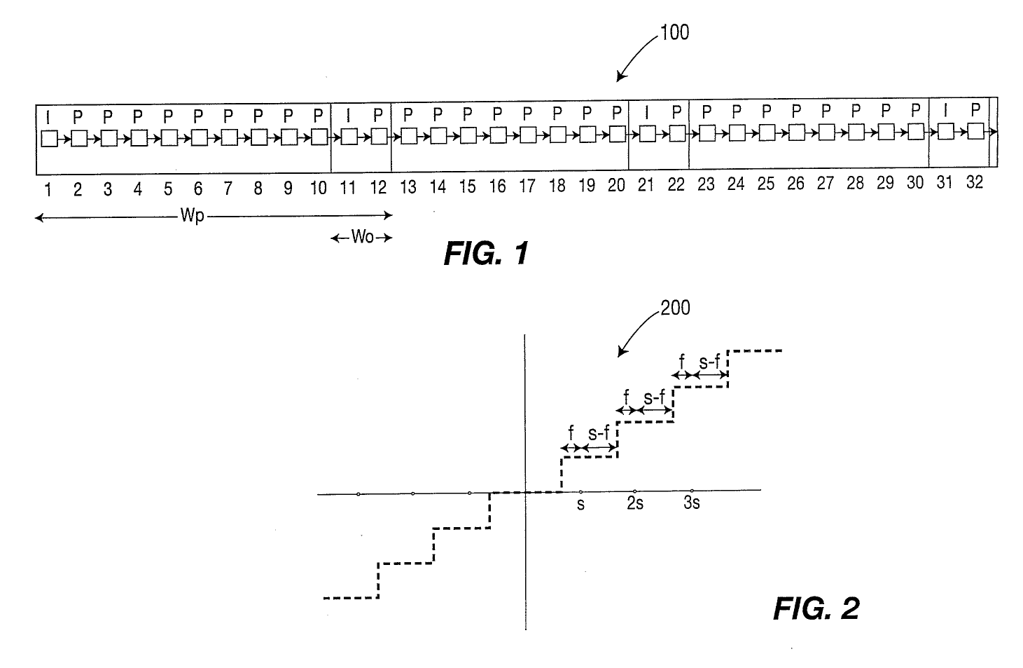

Turning to FIG. 1, a window based two-pass encoding architecture is indicated generally by the reference numeral 100. The processing/analysis window is of size Wₚ pictures, while the overlap allowed between two adjacent groups is of size Wₒ. Processing of the first window would provide some initial statistics that could be used to determine a preliminary set of coding characteristics for all frames within this window. More specifically, if a two-pass scheme is used, then all frames that do not also belong in the future window can be immediately coded based on the generated parameters. Nevertheless, this information can be immediately used for the processing/analysis of this future window. For example, these parameters can be used as initial seeds during the processing of this window and, considering the high temporal correlation that exists in most sequences, can improve the analysis. More importantly, the encoding parameters used for the initial frames of this window, which also belong in the previous window due to the selection of Wₒ, can be further refined/conditioned based on the new generated statistics. This basically allows for a faster convergence to the optimal solution if a larger number of iterations/passes is used, e.g., after processing the entire sequence or M number of adjacent windows. It is obvious that the temporal window can be as large or as small as possible, depending on the capabilities or requirements of the encoder, while also iterations of this scheme could be performed using different window sizes (larger or smaller Wₒ and Wₚ).

Many different criteria could be used during the pre-analysis step of our multi-pass scheme. Such criteria could depend on the complexity constraints of the encoder architecture and could consider from simple spatio-temporal methods (including, but not limited to, edge detection, texture analysis metrics, and absolute image difference) to more complex strategies (including, but not limited to, Discrete Cosine Transfer (DCT) analysis, first pass intra coding, motion estimation/compensation, and even full encoding). Latency can also be adjusted by increasing or decreasing the analysis and/or the overlapping windows.

As an example of such a system, during this analysis the following criteria can be computed:

For every picture k within window Wₚ, the following is computed:
(i) For each Macroblock at position (ij), the mean value MBmean(k,ij), computed as:

$$\begin{matrix}MBmean ( k , i , j ) = \frac{1}{{B}_{W} \times {B}_{H}} {\sum }_{y = 0 , x = 0}^{y = {B}_{H} - 1 , x = {B}_{W} - 1} c [ k , i \times {B}_{w} + \\ x , j \times {B}_{H} + y ] \\ \end{matrix}$$
(ii) the mean square value MBsqmean(k,ij), computed as:

$$\begin{matrix}MBsqmean ( k , i , j ) = \frac{1}{{B}_{W} \times {B}_{H}} {\sum }_{y = 0 , x = 0}^{y = {B}_{H} - 1 , x = {B}_{W} - 1} ( c [ k , i \times {B}_{W} + \\ { x , j \times {B}_{H} + y ] )}^{2} \\ \end{matrix}$$
(iii) the variance value MBvariance(k,ij), computed as:
   MBvariance(k,ij)=MBsqmean(k,ij)−(MBmean(k,ij))²
(iv) and for the entire picture, the Average Macroblock Mean value AMMₖ, computed as:

$${AMM}_{k} = \frac{1}{{PMB}_{W} \times {PMB}_{H}} {\sum }_{j = 0 , i = 0}^{j = {PMB}_{H} - 1 , i = {PMB}_{W} - 1} MBmean ( k , i , j )$$
(v) the Average Macroblock Variance AMVₖ, computed as:

$${AMV}_{k} = \frac{1}{{PMB}_{W} \times {PMB}_{H}} {\sum }_{j = 0 , i = 0}^{j = {PMB}_{H} - 1 , i = {PMB}_{W} - 1} MBvariance ( k , i , j )$$
(vi) and the Picture Variance PVₖ, computed as:

$$\begin{matrix}{PV}_{k} = \frac{1}{{PMB}_{W} \times {PMB}_{H}} {\sum }_{j = 0 , i = 0}^{j = {PMB}_{H} - 1 , i = {PMB}_{W} - 1} \\ MBsqmean ( k , i , j ) - {AMM}_{k}^{2} \\ \end{matrix}$$

where c[x,y] corresponds to the pixel value at position (x,y), PMB_{W} and PMB_{H} are the picture's width and height in macroblocks respectively, and B_{W} and B_{H} are the width and height of each macroblock in the current picture (usually B_{W}=B_{W}=16).

Furthermore, the following temporal characteristics versus picture m (e.g m=k+1) are also computed as follows:
(I) the mean absolute picture difference MAPD_{k,m}, computed as:

$$\begin{matrix}{MAPD}_{k , m} = \frac{1}{{PMB}_{W} \times {PMB}_{H} \times {B}_{W} \times {B}_{H}} \\ {\sum }_{y = 0 , x = 0}^{y = {PMB}_{H} \times {B}_{H} - 1 , x = {PMB}_{W} \times {B}_{W} - 1} \vert c [ k , x , y ] - c [ m , x , y ] \vert \\ \end{matrix}$$
(II) the mean absolute weighted picture difference MAWPD_{k,m}, computed as:

$$\begin{matrix}{MAWPD}_{k , m} = \frac{1}{{PMB}_{W} \times {PMB}_{H} \times {B}_{W} \times {B}_{H}} \\ {\sum }_{y = 0 , x = 0}^{y = {PMB}_{H} \times {B}_{H} - 1 , x = {PMB}_{W} \times {B}_{W} - 1} \\ \vert c [ k , x , y ] - \frac{{AMM}_{k}}{{AMM}_{m}} c [ m , x , y ] \vert\end{matrix}$$
(III) the mean absolute offset picture difference MAWPD_{k,m}, computed as:

$$\begin{matrix}{MAWPD}_{k , m} = \frac{1}{{PMB}_{W} \times {PMB}_{H} \times {B}_{W} \times {B}_{H}} \\ {\sum }_{y = 0 , x = 0}^{y = {PMB}_{H} \times {B}_{H} - 1 , x = {PMB}_{W} \times {B}_{W} - 1} \vert c [ k , x , y ] - c [ m , x , y ] + \\ {AMM}_{k} - {AMM}_{m} \vert\end{matrix}$$
(IV) the mean square picture error MSPE_{k,m}, computed as:

$$\begin{matrix}{MSPE}_{k , m} = \frac{1}{{PMB}_{W} \times {PMB}_{H} \times {B}_{W} \times {B}_{H}} \\ {\sum }_{y = 0 , x = 0}^{y = {PMB}_{H} \times {B}_{H} - 1 , x = {PMB}_{W} \times {B}_{W} - 1} {( c [ k , x , y ] - c [ m , x , y ] )}^{2} \\ \end{matrix}$$
(V) and the absolute picture variance difference APVD_{k,m}, computed as:
   APVD_{k,m}=|PVₖ−PVₘ|

Other spatio-temporal characteristics that can be computed are absolute difference of histograms, histogram of absolute differences, χ² metrics between k and M, edges of k using any (or even multiple) edge operators (including, but not limited to, canny, sobel, or prewitt edge operators), or even field based metrics for the detection of interlace characteristics of a sequence. Two other statistical information that could be useful and could be inferred from the above, are distances of the current picture from the closest past (last_idistanceₖ) and closest future (next_idistanceₖ) coded intra pictures, as measured by, e.g., picture number, coding order, or picture order count (poc). These statistics could be enhanced through the consideration of a scene change/shot detector and/or the default Group of Pictures (GOP) structure. Temporal characteristics could be computed using original or reconstructed images (e.g., if the present invention is applied in a multi-pass implementation), while also the computation of these metrics could also consider motion estimation/compensation.

Based on the above metrics, the encoder may decide to modify certain picture, macroblock, or even sub-block parameters related to the encoding process. These include parameters such as quantization values (QP), coefficient deadzoning/thresholding, lagrangian value for macroblock encoding and also picture level decisions between frames and fields, deblocking filter parameters, coding and reference picture ordering, scene/shot (including, but not limited to, fade/dissove/wipe/flash, and so forth) detection, GOP structure, and so forth.

In one illustrative embodiment of the present invention, the above parameters are considered as follows to perform picture QP adaptation when coding picture k of slice type cur_slice_typeₖ. In this embodiment, distance_{k,k+1} is considered as the distance between two adjacent pictures in terms of picture numbers:

```
if (next_idistanceₖ > 3 && cur_slice_typeₖ == I_Slice)
{
  if (PVₖ<1 && MAPD_{k,k+1}<1 && last_idistanceₖ > 5*distance_{k,k+1})
    QPₖ = QPₖ−4
  else if (MAPD_{k,k+1}<3 && (k==0 || last_idistanceₖ > 5*distance_{k,k+1}))
    QPₖ = QPₖ−3
  else if (MAPD_{k,k+1}<10)
    QPₖ = QPₖ−2
  else if (MAPD_{k,k+1}<15)
    QPₖ = QPₖ−1
}
else if (AMVₖ>10 && AMVₖ<60)
{
  if (PVₖ<500 && next_idistanceₖ > 3*distance_{k,k+1})
  {
    if (MAPD_{k,k+1}<10 && AMVₖ<35 && last_idistanceₖ >
    2*distance_{k,k+1})
      QPₖ = QPₖ−2
    else
      QPₖ = QPₖ−1
}
else if (PVₖ<1500 && next_idistanceₖ > 0)
{
    if (MAPD_{k,k+1}<25)
      QPₖ = QPₖ−1
  }
}
else if (MAPD_{k,k+1}==0 && next_idistanceₖ > 3*distance_{k,k+1} &&
last_idistanceₖ >4*distance_{k,k+1})
  QPₖ = QPₖ−2
else (((MAPD_{k,k+1}<2 && next_idistanceₖ > 3*distance_{k,k+1} &&
last_idistanceₖ >2*distance_{k,k+1})
    || last_idistanceₖ >30) && next_idistanceₖ > 5)
{
  if (MAPD_{k,k+1}<1)
      QPₖ = QPₖ−3
  else if (MAPD_{k,k+1}<4)
      QPₖ = QPₖ−2
  else if (MAPD_{k,k+1}<10)
      QPₖ = QPₖ−1
}
```

In the above embodiment, no consideration was directed at whether the previous or a nearby past picture has already updated its QP due to the above rules. This could result in updating QP values more than necessary, which may be undesirable in terms of Rate-distortion (RD) performance. For this purpose, the parameter last_idistanceₖ is updated to be equal to the value of the last QP adjusted picture regardless of its picture type.

Similarly macroblock/block variance, mean, and edge statistics may be used to determine local encoding parameters. For example, for the selection of a macroblock at position (ij) lagrangian lambda A the following rules can be considered:

if (cur_slice_typeₖ != B_Slice)
{

if (contains_edges(k,i,j))

$λ = 0.5 \times {2}^{\frac{QP - 12}{3}}$

else if (cur_slice_typeₖ == I_Slice)
{

if (MBvariance(k,i,j)<15 || MBvariance(k,i,j)>60)

$λ = 0.58 \times {2}^{\frac{QP - 12}{3}}$

else if (MBvariance(k,i,j)>=15 && MBvariance(k,i,j)<=40)

$λ = 0.65 \times {2}^{\frac{QP - 12}{3}}$

else

$λ = 0.60 \times {2}^{\frac{QP - 12}{3}}$

}
else // cur_slice_typeₖ == P_Slice
{

if (MBvariance(k,i,j)<15 || MBvariance(k,i,j)>60)

$λ = 0.60 \times {2}^{\frac{QP - 12}{3}}$

else if (MBvariance(k,i,j)>15 && MBvariance(k,i,j)<=40)

$λ = 0.70 \times {2}^{\frac{QP - 12}{3}}$

else

$λ = 0.65 \times {2}^{\frac{QP - 12}{3}}$

}

}
else
{

bscale=max(2.00,min(4.00,(QP / 6.0)));
if (contains_edges(k,i,j))

$λ = 0.65 \times bscale \times {2}^{\frac{QP - 12}{3}}$

else
{

if (MBvariance(k,i,j)<15 || MBvariance(k,i,j)>60)

$λ = 0.68 \times bscale \times {2}^{\frac{QP - 12}{3}}$

else if (MBvariance(k,i,j)>15 && MBvariance(k,i,j)<=40)

$λ = 0.72 \times bscale \times {2}^{\frac{QP - 12}{3}}$

else

$λ = 0.70 \times {2}^{\frac{QP - 12}{3}}$

}
if (nal_reference_idc == 1)

λ = 0.80 × λ

}

Similar decisions can be made for the selection of the quantization values or coefficient thresholding that are used for the residual encoding. More specifically quantization of a coefficient W in H.264 is performed as follows:
Z=int({|W|+f×(1<<q_bits)}>>qbits)·sgn(W)
where Z is the final quantized value, while q_bits is based on the current macroblock's quantizer QP. The term f×(1<<q_bits) serves as a rounding term for the quantization process, which “optimally” should be equal to ½×(1<<q_bits). Turning now to FIG. 2, an impact of deadzoning during transformation and quantization is indicated generally by the reference numeral 200. In FIG. 2, the interval around zero is called a dead zone. A deadzone quantizer is characterized by two parameters: the zero bin-width (2s-2f) and the outbin width (s), as shown in FIG. 2. The optimization of the deadzone through f is often used as an efficient method to achieve good rate-distortion performance. Nevertheless, it is well known that the introduction of a deadzone during this process (i.e. reduction of the f term) can usually allow an additional bitrate reduction, while having a small impact in quality. This is especially true for lower resolution content which lack the details (and the film grain information) of higher resolution material. Although f=½ could be used, this could also have a rather significant increase in bitrate and hurt performance in terms of RD evaluation.

Considering that different frequencies are more important than others, an alternative approach would be to take this observation into account in order to improve performance. Instead of using a fixed f value on all transform coefficients, different values are considered, essentially in a matrix approach, where each deadzone parameter is selected based on frequency position. Therefore, Z can now be computed as follows:
Z=int({|W|+f(i, j)×(1<<q_bits)}>>qbits)·sgn(W)
where i and j correspond to the current column or row within the block transform coefficients. The array f can now depend on slice or macroblock type, and also on the texture characteristics (variance or edge information) of the current block. If a block, for example, contains edges, or has low variance characteristics, it is important not to introduce further artifacts due to the deadzoning process since these would be more visible. On the other hand, blocks with high spatial activity can mask more artifacts, and deadzoning could be increased without a significant impact in quality. Deadzoning could also be changed depending on whether the current block provides any useful information for blocks in a future picture (i.e., if any pixel within the current block is used or is not used for predicting other pixels).

As an example, the following deadzoning matrices could be used if a 4×4 transform is used:

if (cur_slice_typeₖ == I_Slice)
{

if (MBvariance(k,i,j)<15 || MBvariance(k,i,j)>60)

$f = [ \begin{matrix}1 \text{/} 2 & 1 \text{/} 2 & 1 \text{/} 2 & 1 \text{/} 3 \\ 1 \text{/} 2 & 1 \text{/} 2 & 1 \text{/} 2 & 1 \text{/} 3 \\ 1 \text{/} 2 & 1 \text{/} 2 & 1 \text{/} 3 & 1 \text{/} 4 \\ 1 \text{/} 3 & 1 \text{/} 3 & 1 \text{/} 4 & 1 \text{/} 5\end{matrix} ]$

else if (MBvariance(k,i,j) >=15 &&MBvariance(k,i,j)<=40 || contains_edges(k,i,j))

$f = [ \begin{matrix}1 \text{/} 2 & 1 \text{/} 2 & 1 \text{/} 2 & 1 \text{/} 2 \\ 1 \text{/} 2 & 1 \text{/} 2 & 1 \text{/} 2 & 1 \text{/} 2 \\ 1 \text{/} 2 & 1 \text{/} 2 & 1 \text{/} 2 & 1 \text{/} 2 \\ 1 \text{/} 2 & 1 \text{/} 2 & 1 \text{/} 2 & 1 \text{/} 2\end{matrix} ]$

else

$f = [ \begin{matrix}1 \text{/} 2 & 1 \text{/} 2 & 1 \text{/} 2 & 1 \text{/} 2 \\ 1 \text{/} 2 & 1 \text{/} 2 & 1 \text{/} 2 & 1 \text{/} 3 \\ 1 \text{/} 2 & 1 \text{/} 2 & 1 \text{/} 3 & 1 \text{/} 4 \\ 1 \text{/} 2 & 1 \text{/} 3 & 1 \text{/} 4 & 1 \text{/} 5\end{matrix} ]$

}
else if (cur_slice_typeₖ P_Slice)
{

if (MBvariance(k,i,j)<15 || MBvariance(k,i,j)>60)

$f = [ \begin{matrix}1 \text{/} 3 & 2 \text{/} 7 & 4 \text{/} 15 & 2 \text{/} 9 \\ 2 \text{/} 7 & 4 \text{/} 15 & 2 \text{/} 9 & 1 \text{/} 6 \\ 4 \text{/} 15 & 2 \text{/} 9 & 1 \text{/} 6 & 1 \text{/} 7 \\ 2 \text{/} 9 & 1 \text{/} 6 & 1 \text{/} 7 & 2 \text{/} 15\end{matrix} ]$

else if (MBvariance(k,i,j) >15&&MBvariance(k,i,j) <40 || contains_edges(k,i,j))

$f = [ \begin{matrix}1 \text{/} 2 & 1 \text{/} 3 & 2 \text{/} 7 & 2 \text{/} 9 \\ 1 \text{/} 3 & 4 \text{/} 15 & 2 \text{/} 9 & 1 \text{/} 6 \\ 2 \text{/} 7 & 2 \text{/} 8 & 1 \text{/} 6 & 1 \text{/} 7 \\ 2 \text{/} 9 & 1 \text{/} 6 & 1 \text{/} 7 & 2 \text{/} 15\end{matrix} ]$

else

$f = [ \begin{matrix}2 \text{/} 5 & 1 \text{/} 3 & 4 \text{/} 15 & 2 \text{/} 9 \\ 1 \text{/} 3 & 4 \text{/} 15 & 2 \text{/} 9 & 1 \text{/} 6 \\ 4 \text{/} 15 & 2 \text{/} 9 & 1 \text{/} 6 & 1 \text{/} 7 \\ 2 \text{/} 9 & 1 \text{/} 6 & 1 \text{/} 7 & 2 \text{/} 15\end{matrix} ]$

}
else // B_slices
{

$f = [ \begin{matrix}1 \text{/} 4 & 1 \text{/} 6 & 1 \text{/} 6 & 1 \text{/} 6 \\ 1 \text{/} 6 & 1 \text{/} 6 & 1 \text{/} 6 & 1 \text{/} 7 \\ 1 \text{/} 6 & 1 \text{/} 6 & 1 \text{/} 7 & 1 \text{/} 7 \\ 1 \text{/} 6 & 1 \text{/} 7 & 1 \text{/} 7 & 1 \text{/} 7\end{matrix} ]$

}

Under certain conditions, it might be impossible for the encoder to perform temporal analysis using future frames. In this case, temporal analysis could be performed while considering only previously coded pictures, and by assuming that future pictures have similar temporal characteristics. For example, if the current picture has high similarity (e.g., MAPD_{k,k-1} is small), then it is assumed that also the similarity with the next picture to be coded (MAPD_{k,k+1}) would also be small. Thus, adaptation of the encoding parameters could be based on already available information, while replacing all indices (k,k+1) with (k,k−1).

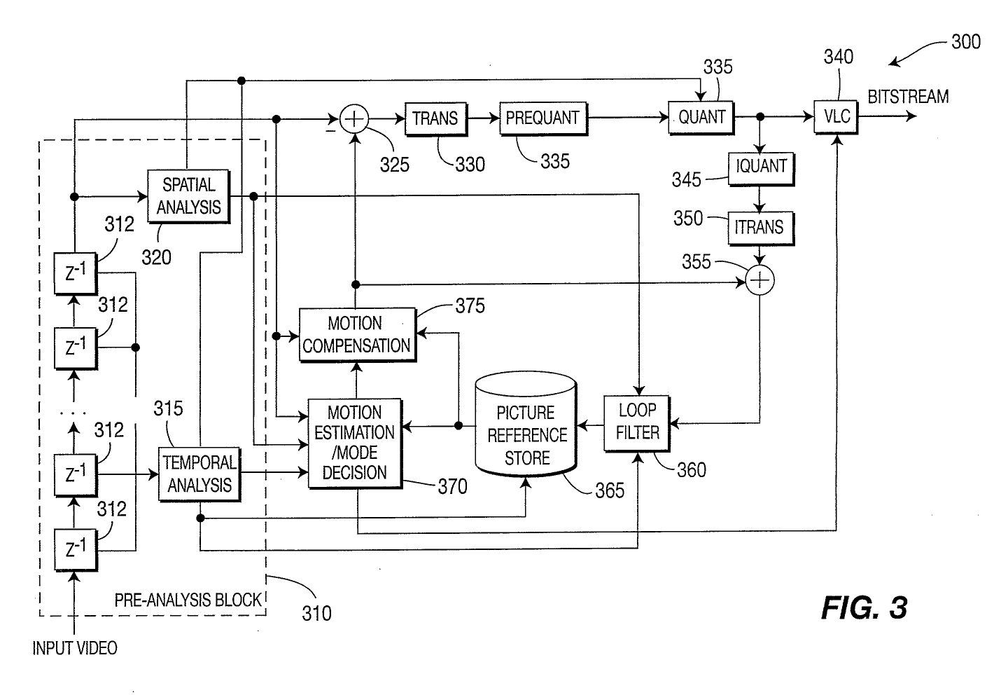

Turning now to FIG. 3, a video encoder is indicated generally by the reference numeral 300. An input of the video encoder 300 is connected in signal communication with an input of a pre-analysis block 310. The pre-analysis block 310 includes a plurality of frame delays 312 connected in signal communication to each other such that each of the plurality of frame delays 312 is connected sequentially in serial and all in parallel, the latter via a parallel signal path. The parallel signal path is also connected in signal communication with an input of a temporal analyzer 315. An output of the last frame delay 312 connected in serial and farthest away from the input of the encoder 300 is connected in signal communication with an input of a spatial analyzer 320, with an inverting input of a first summing junction 325, with a first input of a motion compensator 375 and with a first input of a motion estimator/mode decision block 370. An output of the first summing junction 325 is connected in signal communication with an input of a transformer 330. An output of the transformer 330 is connected in signal communication with a first input of a quantizer 335. An output of the quantizer 335 is connected in signal communication with a first input of a variable length coder 340 and with an input of an inverse quantizer 345. An output of the variable length coder 340 is an externally available output of the video encoder 300. An output of the inverse quantizer 345 is connected in signal communication with an input of an inverse transformer 350. An output of the inverse transformer is connected in signal communication with a non-inverting first input of a second summing junction 355. An output of the second summing junction 355 is connected in signal communication with a first input of a loop filter 360. An output of the loop filter 360 is connected in signal communication with a first input of a picture reference store 365. An output of the picture reference store 365 is connected in signal communication with a second input of the motion estimator/mode decision block 370 and with a second input of the motion compensator 375. A first output of the motion estimator/mode decision block 370 is connected in signal communication with a second input of the variable length coder 340. A second output of the motion estimator/mode decision block 370 is connected in signal communication with a third input of the motion compensator 375. An output of the motion compensator 375 is connected in signal communication with a non-inverting input of the first summing junction 325, and with a non-inverting second input of the second summing junction 355. A first output of the spatial analyzer 320 is connected in signal communication with a second input of the quantizer 335. A second output of the spatial analyzer 320 is connected in signal communication with a second input of the loop filter 360, with a third input of the motion estimator/mode decision block 370, and with the non-inverting input of the first summing junction 325. A first output of the temporal analyzer 315 is connected in signal communication with the second input of the quantizer 335. A second output of the temporal analyzer 315 is connected in signal communication with a fourth input of the motion estimator/mode decision block 370. A third output of the temporal analyzer 315 is connected in signal communication with a third input of the loop filter 360 and with a second input of the picture reference store 365.

A group of pictures is considered during a temporal analysis step, which decides several parameters, including slice type decision, GOP structure, weighting parameters (through the motion estimator/mode decision block 370), quantization values and deadzoning (through the quantizer 335), reference order and handling (picture reference store 365), picture coding ordering, frame/field picture level adaptive decision, and even deblocking parameters (loop filter 360). Similarly, spatial analysis is performed on each coded frame, which can similarly impact quantization and deadzoning (quantizer 335), lagrangian parameters and slice type decision (Motion Estimation/Mode Decision block 370), inter/intra mode decision, frame/field picture level and macroblock level adaptive decision and deblocking (loop filter 360).

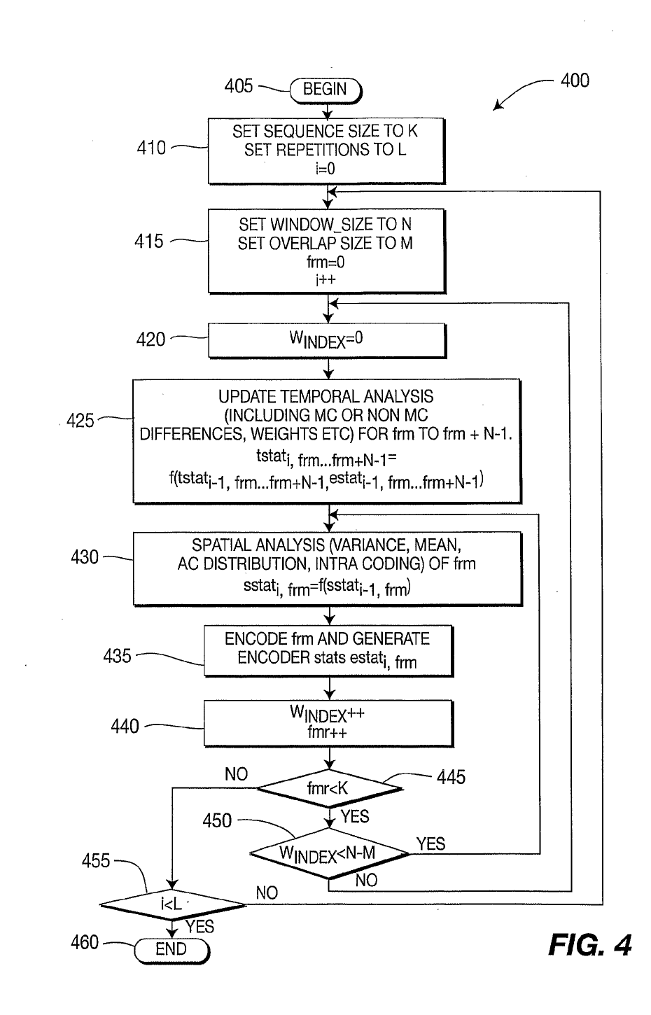

Turning now to FIG. 4, an exemplary process for encoding video signal data is indicated generally by the reference numeral 400. The process can analyze or encode the same bitstream multiple times while collecting and updating the required statistics in each iteration. These statistics are used in each subsequent pass to improve the encoding performance by adapting the encoder parameters given the video characteristics or user requirements. In particular, k frames (i.e., excluding non-stored pictures) are to be encoded, with L number of passes (also referred to herein as “repetitions” and “iterations”) and a window of size (N,M) where N is the total number of frames within the window and M is the number of overlapping frames between adjacent windows. The frame that is to be encoded is indexed using the variable frm, while the current position within a window is indexed using the variable w_{index}.

The process includes a begin block 405 that passes control to a function block 410. The function block 410 sets the sequence size to k, sets the number of repetitions to L, sets a variable i to zero (0), and passes control to a function block 415. The function block 415 sets the window size to N, sets the overlap size to M, sets the variable frm to zero (0), and passes control to a function block 420. The function block 420 sets the variable w_{index} to zero (0), and passes control to a function block 425. Thus, it is to be appreciated that for each encoding pass, the window parameters are initialized. This allows the use of different window sizes or even to adapt them based on previous analysis steps (e.g., if a scene change was detected, then N and M could be adjusted accordingly to include only a complete scene).

The function block 425 performs temporal analysis for each window to be processed while considering all N frames within the window, generates temporal statistics (tstat_{i,frm . . . frm+N-1}), and optionally adapts or refines statistics from previous passes or encoding steps using the current statistics. The function block 425 then passes control to a function block 430. The function block 430 performs spatial analysis for the frame with index frm (w_{index} within the current window) until the condition w_{index}<N-M is no longer satisfied, and passes control to a function block 435. The function block 435 encodes these frames based on the results from the temporal and spatial analysis, generates/collects encoder statistics that can be used if multiple passes are required, and passes control to a function block 440.

Function block 440 increments the values of variables frm and w_{index}, and passes control to a decision block 445, The decision block 445 determines whether or not the variable frm is less than k.

If the variable frm is less than k, then control passes to a decision block 450 that determines whether or not w_{index} is less than (N-M). Otherwise, if the variable frm is not less than k, then control passes to a decision block 455 that determines whether or not i is less than L.

If w_{index} is less than (N-M), then control is passed back to function block 430. Otherwise, if w_{index} is not less than (N-M), then control is passed back to function block 420.

If i is not less than L, then control is passed back to function block 415. Otherwise, i is less than L, then control is passed to an end block 460.

A description will now be given of some of the many attendant advantages/features of the present invention, according to various illustrative embodiments of the present invention. For example, one advantage/feature is the providing of an encoding apparatus and method that performs video analysis based on constrained but overlapping windows of the content to be coded, and uses this information to adapt encoding parameters. Another advantage/feature is the use of spatio-temporal analysis in the video analysis. Yet another advantage/feature is that a preliminary encoding pass is considered for the video analysis. Moreover, another advantage/feature is that spatio-temporal analysis and a preliminary encoding pass are jointly considered in the video analysis. Also, another advantage/feature is that at least one of picture coding type, edge, mean, and variance information is used for spatial analysis, and adaptation of lagrangian parameters, quantization and deadzoning. Still another advantage/feature is that absolute difference and variance are used to adapt quantization parameters. Additionally, another advantage/feature is that the performed video analysis only considers previously coded pictures. Further, another advantage/feature is that the performed video analysis is used to decide at least one of several encoding parameters including, but not limited to, slice type decision, GOP and picture coding structure and order, weighting parameters, quantization values and deadzoning, lagrangian parameters, number of references, reference order and handling, frame/field picture and macroblock decisions, deblocking parameters, inter block size decision, intra spatial prediction, and direct modes. Also, another advantage/feature is that the video analysis can be performed using multiple iterations, while considering previously generated statistics to adapt the encoding parameters or the analysis statistics. Moreover, another advantage/feature is that window sizes and overlapping window regions are adaptable based on previously generated analysis statistics.

These and other features and advantages of the present invention may be readily ascertained by one of ordinary skill in the pertinent art based on the teachings herein. It is to be understood that the teachings of the present invention may be implemented in various forms of hardware, software, firmware, special purpose processors, or combinations thereof.

Most preferably, the teachings of the present invention are implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

1. An encoder for encoding video signal data corresponding to a plurality of pictures, the encoder comprising an overlapping window analysis unit for performing a video analysis of the video signal data using a plurality of overlapping analysis windows with respect to at least some of the plurality of pictures corresponding to the video signal data, and for adapting encoding parameters for the video signal data based on a result of the video analysis.

2. The encoder as defined in claim 1, wherein said overlapping windows analysis unit performs the video analysis of the video signal data using spatio-temporal analysis.

3. The encoder as defined in claim 2, wherein said overlapping windows analysis unit uses at least one of picture coding type information, edge information, mean information, and variance information for at least one of the spatio-temporal analysis, and for adaptation of lagrangian parameters and quantization parameters and deadzoning.

4. The encoder as defined in claim 3, wherein said overlapping windows analysis unit adapts the quantization parameters using absolute difference and variance.

5. The encoder as defined in claim 1, wherein said overlapping windows analysis unit performs the video analysis of the video signal data using a preliminary encoding pass.

6. The encoder as defined in claim 1, wherein said overlapping windows analysis unit performs the video analysis of the video signal data using both spatio-temporal analysis and a preliminary encoding pass.

7. The encoder as defined in claim 6, wherein said overlapping windows analysis unit uses at least one of picture coding type information, edge information, mean information, and variance information for at least one of the spatio-temporal analysis, for adaptation of lagrangian parameters and quantization parameters, and for deadzoning.

8. The encoder as defined in claim 7, wherein said overlapping windows analysis unit adapts the quantization parameters using absolute difference and variance.

9. The encoder as defined in claim 1, wherein the video signal data comprises a plurality of frames, each of the plurality of frames representing a corresponding picture, and said overlapping analysis unit performs the video analysis so as to consider only previously coded pictures.

10. The encoder as defined in claim 1, wherein the encoding parameters comprise at least one of slice type, picture and Group of Pictures (GOP) coding structure and order, weighting parameters, quantization values and deadzoning, lagrangian parameters, a number of references, reference order and handling, frame/field picture and macroblock parameters, deblocking parameters, inter block size, intra spatial prediction, and direct modes.

11. The encoder as defined in claim 1, wherein said overlapping windows analysis unit performs the video analysis over multiple iterations, and adapts one of the encoding parameters and analysis statistics based on the previously generated analysis statistics.

12. The encoder as defined in claim 1, wherein each of the overlapping windows has a window size of P pictures and an overlap size associated therewith, and said overlapping windows analysis unit adapts the window size and the overlap size based on previously generated analysis statistics.

13. A method for encoding video signal data corresponding to a plurality of pictures, comprising the steps of:
performing a video analysis of the video signal data using a plurality of overlapping analysis windows with respect to at least some of the plurality of pictures corresponding to the video signal data; and
adapting encoding parameters for the video signal data based on a result of the video analysis.

14. The method as defined in claim 13, wherein said performing step performs the video analysis of the video signal data using spatio-temporal analysis.

15. The method as defined in claim 14, wherein said performing and adapting steps respectively use at least one of picture coding type information, edge information, mean information, and variance information for at least one of the spatio-temporal analysis, and for adaptation of lagrangian parameters and quantization parameters and deadzoning.

16. The method as defined in claim 15, wherein the quantization parameters are adapted using absolute difference and variance.

17. The method as defined in claim 13, wherein said performing step performs the video analysis of the video signal data using a preliminary encoding pass.

18. The method as defined in claim 13, wherein said performing step performs the video analysis of the video signal data using both spatio-temporal analysis and a preliminary encoding pass.

19. The method as defined in claim 18, wherein said performing and adapting steps respectively use at least one of picture coding type information, edge information, mean information, and variance information for at least one of the spatio-temporal analysis, for adaptation of lagrangian parameters and quantization parameters, and for deadzoning.

20. The method as defined in claim 19, wherein the quantization parameters are adapted using absolute difference and variance.

21. The method as defined in claim 13, wherein the video signal data comprises a plurality of frames, each of the plurality of frames representing a corresponding picture, and said performing step performs the video analysis so as to consider only previously coded pictures.

22. The method as defined in claim 13, wherein the encoding parameters comprise at least one of slice type, picture and Group of Pictures (GOP) coding structure and order, weighting parameters, quantization values and deadzoning, lagrangian parameters, a number of references, reference order and handling, frame/field picture and macroblock parameters, deblocking parameters, inter block size, intra spatial prediction, and direct modes.

23. The method as defined in claim 13, wherein said performing step performs the video analysis over multiple iterations, and said adapting step adapts one of the encoding parameters and analysis statistics based on the previously generated analysis statistics.

24. The method as defined in claim 13, wherein each of the overlapping windows has a window size and an overlap size associated therewith, and said performing step comprises the step of adapting the window size and the overlap size based on previously generated analysis statistics.
